(19) United States
(12) Patent Application Publication
(10) Pub. No.: US 2012/0132319 A1
(43) Pub. Date: May 31, 2012

(54) TWO-SIDED WOOD WORKING PLANNER

(76) Inventor: Bor-Yann CHUANG, Taiping City (TW)

(21) Appl. No.: 12/954,857

(22) Filed: Nov. 27, 2010

(51) Int. Cl. B27C 1/08

(52) U.S. Cl. 144/130

(57) ABSTRACT

A two-sided wood working planner includes a base, an adjustment seat and at least two auxiliary pressure cylinders. The base includes a plurality of straight screws thereon. The adjustment seat has a plurality of threaded holes corresponding to the screws. The screws are screwed to the threaded holes, so that the adjustment seat is mounted above the base. Two ends of each auxiliary pressure cylinder are connected to the base and the adjustment seat, respectively. The auxiliary pressure cylinder has a prestressing force to lift the adjustment seat with respect to the base. The flank at one side of threads of the screw is against the corresponding flank of threads of the threaded hole to eliminate the backlash between the threads so as to prevent the adjustment seat from vibrating during the operation of the two-sided wood working planner.

### BACKGROUND OF THE INVENTION

1. Field of the Invention

The present invention relates to a two-sided wood working planner.

2. Description of the Prior Art

A conventional wood working planner comprises a base and an adjustment seat. The base includes a worktable thereon. The worktable includes a plurality of screws on a circumferential portion thereof. The adjustment seat has a plurality of threaded holes corresponding to the screws. The adjustment seat is mounted above the worktable. The user can rotate the adjustment wheel to move the screws upward or downward for adjusting the position of the adjustment seat. However, there will be backlash formed between the threads, namely, there will be a gap between the threads of the screw and the threaded hole. During operation, the wood working planner vibrates easily, which will influence the working quality. Besides, the adjustment seat is heavy. It is not easy to adjust the adjustment seat. In particular, when the adjustment seat is moved upward, subject to the gravity, the user will need much strength to do the adjustment. Accordingly, the inventor of the present invention has devoted himself based on his many years of practical experiences to solve this problem.

### SUMMARY OF THE INVENTION

The primary object of the present invention is to provide a two-sided wood working planner. The two-sided wood working planner comprises a base. The base comprises a worktable thereon. The worktable includes a plurality of straight screws on a circumferential portion thereof. The screws are parallel to each other. The two-sided wood working planner further comprises an adjustment seat which is disposed above the worktable. The adjustment seat has a plurality of threaded holes corresponding to the screws. The screws are screwed to the threaded holes. The adjustment seat is mounted above the worktable and adjustable. The two-sided wood working planner further comprises at least two auxiliary pressure cylinders each having a pressure cylinder body. Two ends of the pressure cylinder body are connected to the base and the adjustment seat, respectively. The pressure cylinder body has a prestressing force to lift the adjustment seat with respect to the base. Thereby, through the prestressing force of the auxiliary pressure cylinders, the flank at one side of threads of the screw is against the corresponding flank of threads of the threaded hole to eliminate the backlash between the threads so as to prevent the adjustment seat from vibrating during the operation of the two-sided wood working planner. The present invention can enhance the working quality. The user can adjust the position of the adjustment seat through the adjustment wheel without much strength because the auxiliary pressure cylinders have the prestressing force to lift the adjustment seat with respect to the base to counteract a part of the gravity. It is labor-saving to adjust the adjustment seat upward or downward.

### BRIEF DESCRIPTION OF THE DRAWINGS

FIG. 1 is a perspective view according to a preferred embodiment of the present invention;

FIG. 2 is an exploded view according to the preferred embodiment of the present invention; and

FIG. 3 is a partially enlarged view according to the preferred embodiment of the present invention.

### DETAILED DESCRIPTION OF THE PREFERRED EMBODIMENTS

Embodiments of the present invention will now be described, by way of example only, with reference to the accompanying drawings.

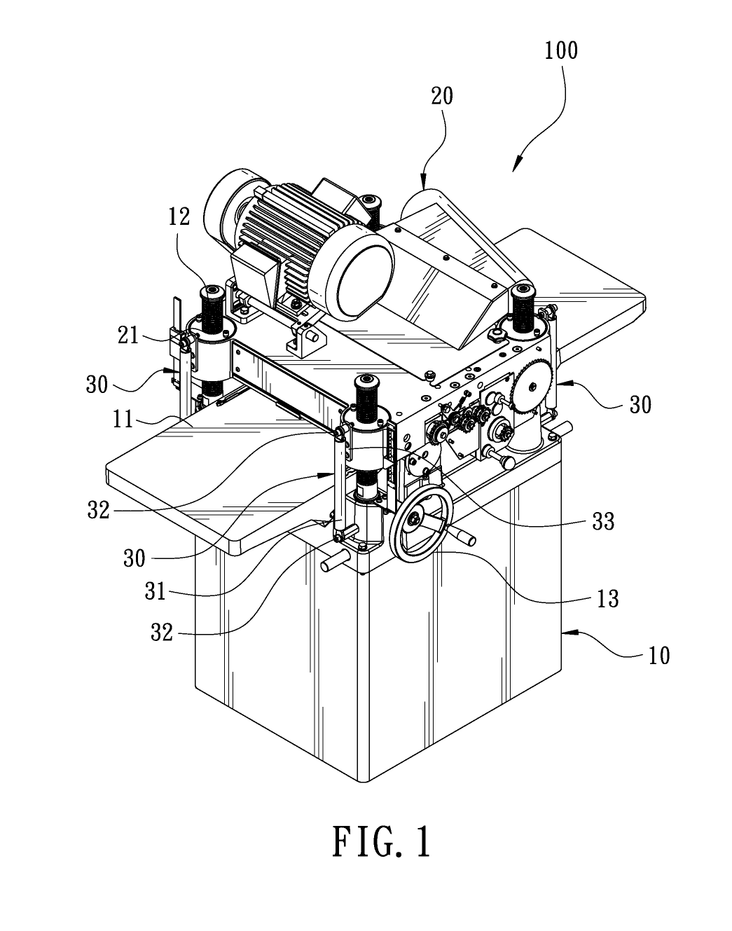

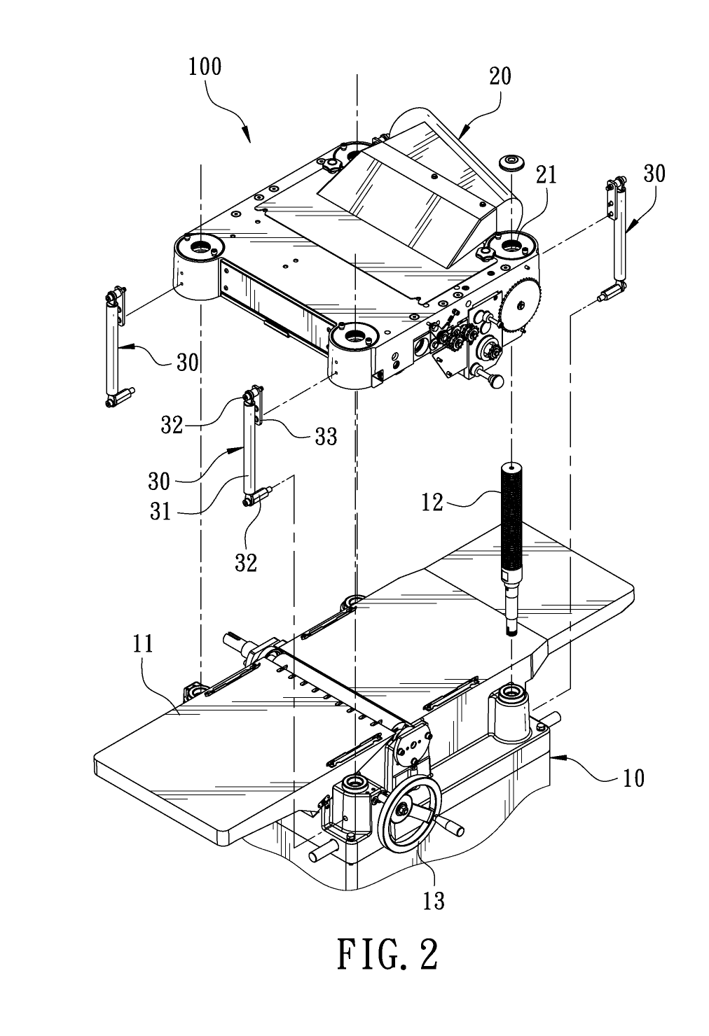

As shown in FIG. 1 and FIG. 2, a two-sided wood working planner 100 according to a preferred embodiment of the present invention comprises a base 10, an adjustment seat 20, and at least two auxiliary pressure cylinders 30.

The base comprises a worktable 11 thereon. The worktable 11 includes a plurality of straight screws 12 on a circumferential portion thereof. The screws 12 are connected with an adjustment wheel 13. The adjustment wheel 13 can be rotated to move the screws 12.

The adjustment seat 20 is disposed above the worktable 11. The adjustment seat 20 has a plurality of threaded holes 21 corresponding to the screws 12. The screws 12 are screwed to the threaded holes 21, such that the adjustment seat 20 is mounted above the worktable 11 and can be adjusted upward or downward.

Each auxiliary pressure cylinder 30 has a pressure cylinder body 31. The pressure cylinder body 31 can be a pneumatic cylinder or an oil pressure cylinder. Two ends of the pressure cylinder body 31 are connected to the base 10 and the adjustment seat 20, respectively. The pressure cylinder body 31 has a prestressing force to lift the adjustment seat 20 with respect to the base 10. In this embodiment, each screw 12 of the two-sided wood working planner 100 is provided with one auxiliary pressure cylinder 30. The pressure cylinder body 31 of the auxiliary pressure cylinder 30 is parallel to the corresponding screw 12 and disposed at one side of the adjustment seat 20 close to the corresponding screw 12. Two ends of the pressure cylinder body 31 are pivotally and transversely connected with a pair of fixing bolts 32. Through the fixing bolts 32, the two ends of the pressure cylinder body 31 are connected to the base 10 and the adjustment seat 20, respectively. The fixing bolt 32 connected to the adjustment seat 20 is first connected to a fixing plate 33 and then connected to the adjustment seat 20 through the fixing plate 33.

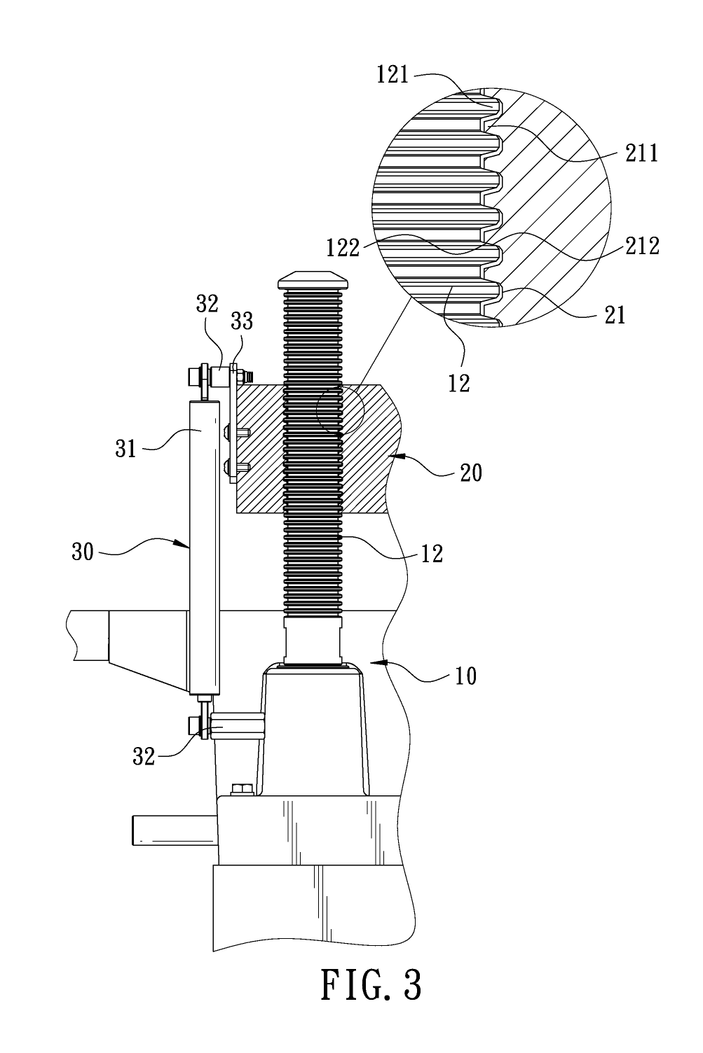

FIG. 3 is a partially enlarged view according to the preferred embodiment of the present invention. Because the auxiliary pressure cylinders 30 are connected between the base 10 and the adjustment seat 20, the auxiliary pressure cylinders 30 have the prestressing force to lift the adjustment seat 20 with respect to the base 10. As shown in FIG. 3, the flank of threads 121 of the screw 12 is against the corresponding flank of threads 211 of the threaded hole 21 to eliminate the backlash between the threads so as to prevent the adjustment seat 20 from vibrating during the operation of the two-sided wood working planner 10. The present invention can enhance the working quality.

The user can adjust the position of the adjustment seat 20 through the adjustment wheel 13 without much strength because the auxiliary pressure cylinders 30 have the prestressing force to lift the adjustment seat 20 with respect to the base 10 to counteract a part of the gravity. It is labor-saving to adjust the adjustment seat 20 upward or downward.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A two-sided wood working planner, comprising:
a base comprising a worktable thereon, the worktable including a plurality of straight screws on a circumferential portion thereof, the screws being parallel to each other;
an adjustment seat disposed above the worktable, the adjustment seat having a plurality of threaded holes corresponding to the screws, the screws being screwed to the threaded holes, the adjustment seat being mounted above the worktable and adjustable; and
at least two auxiliary pressure cylinders each having a pressure cylinder body, two ends of the pressure cylinder body being respectively connected to the base and the adjustment seat, the pressure cylinder body having a prestressing force to lift the adjustment seat with respect to the base;
thereby, through the prestressing force of the auxiliary pressure cylinders, the flank at one side of threads of the screw being against the corresponding flank of threads of the threaded hole to eliminate the backlash between the threads so as to prevent the adjustment seat from vibrating during the operation of the two-sided wood working planner.

2. The two-sided wood working planner as claimed in claim 1, wherein the pressure cylinder body is parallel to the corresponding screw and disposed at one side of the adjustment seat close to the corresponding screw.

3. The two-sided wood working planner as claimed in claim 1, wherein two ends of the pressure cylinder body are pivotally and transversely connected with a pair of fixing bolts, and the two ends of the pressure cylinder body are respectively connected to the base and the adjustment seat through the fixing bolts.

4. The two-sided wood working planner as claimed in claim 3, wherein the fixing bolt connected to the adjustment seat is first connected to a fixing plate and then connected to the adjustment seat through the fixing plate.
